(19) United States
(12) Patent Application Publication
(10) Pub. No.: US 2006/0185533 A1
(43) Pub. Date: Aug. 24, 2006

(54) Roller arrangement for embossing web-shaped materials

(76) Inventor: Kilian Saueressig, Vreden (DE)

Correspondence Address: PILLSBURY WINTHROP SHAW PITTMAN LLP, 1650 TYSONS BOULEVARD, MCLEAN, VA, 22102, US

(21) Appl. No.: 10/550,696

(22) PCT Filed: Aug. 31, 2004
(86) PCT No.: PCT/DE04/01920

§ 371 Date: Sep. 27, 2005

(30) Foreign Application Priority Data
Sep. 9, 2003 (DE) 20313976.3

(51) Int. Cl. B41F 19/02; B44B 5/00; A01B 29/00

(52) U.S. Cl. 101/22; 101/3.1; 492/30

(57) ABSTRACT

A roller arrangement for embossing web-shaped materials, in particular, web-shaped paper and tissue materials, is disclosed. A roller arrangement comprises a punch, which includes a first embossing pattern, containing a plurality of spaced-apart elevations, and a matrix which includes a second embossing pattern, containing a plurality of spaced-apart elevations. The elevations on the first embossing pattern can be lowered into free spaces in between elevations of the second embossing pattern. Elevations on embossing patterns on punches and matrixes are positioned in rows spaced apart in a circumferential direction. At least one cleaning roller is provided, which comprises cleaning elements arranged in a circumferential direction that interact with a punch or a matrix in between rows of elevations on embossing patterns of punches and matrixes.

This application is a national stage application of International Application No. PCT/DE2004/001920, filed Aug. 31, 2004, which is herein incorporated by reference in its entirety.

### BACKGROUND

1. Field of the Invention

The present invention relates generally to embossing. More particularly, embodiments of the present invention relate to an apparatus for cleaning deposits on an embossing roller during an embossing process.

2. Background of the Invention

Embossing is a popular technique for creating three-dimensional designs on or creating textures in substrates, such as web-shaped paper or tissue material. To emboss a substrate, an embossing pattern on an embossing roller rolls over a substrate, for example tissue paper, and the embossing pattern breaks fibers in the paper. During embossing, sediment, such as paper fibers and dust, adhere to gaps within embossing patterns, which seriously contaminate embossing rollers. One solution to this problem is to halt production to allow for cleaning of embossing rollers. Another solution to address this problem includes complex devices that require spraying water or solvent on embossing rollers to wash away sediment. Such solutions are costly or can lead to larger difficulties such as clogging of embossing rollers. Consequently, a need exists for a cost-effective and design-effective device for embossing web-shaped materials that remains clean of sediment during operation.

### BRIEF SUMMARY OF THE INVENTION

The present invention is directed toward a roller arrangement for embossing web-shaped materials that allows for cleaning during operation. An embodiment of the present invention provides a roller arrangement for embossing web-shaped materials, such as web-shaped paper and tissue materials, comprising at least one embossing roller and a cleaning roller. An embossing pattern of a plurality of elevations is disposed on the embossing roller. A plurality of cleaning elements is disposed on the cleaning roller. The embossing roller can comprise either a punch or a matrix.

Another embodiment of the present invention includes a punch, a matrix, and a cleaning roller. A first embossing pattern of a plurality of elevations is disposed on the punch. A second embossing pattern of a plurality of elevations is disposed on the matrix. A plurality of cleaning elements is disposed on the cleaning roller. Elevations of punches and matrixes and cleaning elements can be aligned in rows spaced apart in a circumferential direction. Elevations of the first embossing pattern can be arranged such that they can be lowered into free spaces between elevations of the second embossing pattern. Cleaning elements of the cleaning roller can be arranged in such a way to allow interaction with a punch or a matrix. Interaction between cleaning elements and elevations of a punch or a roller can occur in between rows of the elevations. This configuration allows the cleaning elements to remove sediment collecting in between rows of elevations of punches and matrixes.

Another embodiment of the present invention provides a method for embossing web-shaped material by running an embossing roller on web-shaped material, where a plurality of elevations are arranged on the embossing roller in rows that are spaced apart in a circumferential direction. A cleaning roller is positioned adjacent to the embossing roller, where a plurality of cleaning elements are aligned on the cleaning roller to fit in between the rows of the embossing roller. The plurality of cleaning elements run in between the rows of the embossing roller to remove sediment.

### BRIEF DESCRIPTION OF THE DRAWINGS

FIG. 1 is a schematic diagram showing an exemplary punch in accordance with a first embodiment of the present invention.

FIG. 2 is a schematic diagram showing an exemplary cleaning roller that can interact with a punch such as that embodied in FIG. 1.

FIG. 3 is a schematic diagram showing an exemplary punch in accordance with a second embodiment of the present invention.

FIG. 4 is a schematic diagram showing an exemplary cleaning roller that can interact with a punch such as that embodied in FIG. 3.

FIG. 5 is a schematic diagram showing an exemplary path of cleaning elements embodied in FIG. 2 between elevations on a punch such as that embodied in FIG. 1.

FIG. 6 is a schematic diagram showing an exemplary path of cleaning elements embodied in FIG. 4 between elevations on a punch such as that embodied in FIG. 3.

FIG. 7 is a schematic diagram showing an exemplary punch in accordance with a third embodiment of the present invention.

FIG. 8 is a schematic diagram showing an exemplary cleaning roller that can interact with a punch such as that embodied in FIG. 7.

FIG. 9 is a schematic diagram showing an exemplary path of cleaning elements embodied in FIG. 8 between elevations on a punch such as that embodied in FIG. 7.

### DETAILED DESCRIPTION OF THE INVENTION

An embodiment of the present invention provides a roller arrangement for embossing web-shaped materials, such as web-shaped paper and tissue materials, comprising at least two embossing rollers and at least one cleaning roller. An embossing roller can be either a punch or a matrix. A punch includes a first embossing pattern with a plurality of spaced-apart elevations. A matrix includes a second embossing pattern with a plurality of spaced-apart elevations. Elevations on the first embossing pattern can be lowered into free spaces on the second embossing pattern.

When a first embossing pattern and a second embossing pattern of a punch and matrix are geometrically adjusted on top of each other in such a way that elevations mutually and substantially correspond at a number of locations, micro-fissure embossing is possible. The first and second embossing patterns break fibers of a web-shaped material, thus greatly increasing the water absorbency capability of the fibers. During embossing of web-shaped materials, such as web-shaped paper and tissue materials, sediment such as paper fiber and dust, adhere to gaps within embossing patterns, which can seriously contaminate punches and matrixes.

In accordance with an embodiment of the present invention, elevations on an embossing pattern of a punch or matrix are arranged in rows that are spaced apart in a circumferential direction. Elevations on an embossing pattern can also be arranged in a checker board pattern. For example, elevations could, when seen from a top view, be cross-, square-, oval-shaped or shaped in other similar configurations, as long as a desired micro-fissure embossing is achieved as a punch and matrix interact.

In accordance with an embodiment of the present invention, at least one cleaning roller is provided, which comprises cleaning elements that can be arranged in a circumferential direction that can run between rows of elevations on embossing patterns of punches or matrixes. Cleaning elements can be knife-like cleaning studs of such a geometry to conform to a geometry of an embossing pattern. A punch or a matrix can be fitted with a cleaning roller that can be located outside a path of a web-shaped material to allow interaction with the punch or the matrix. During operation, cleaning elements continuously run in a circumferential direction between elevations on each embossing pattern, cleaning out sediment such as paper fibers and dust.

Because cleaning elements run in a circumferential direction of a cleaning roller, the cleaning roller itself is cleaned. Cleaning elements can also be radially offset in an axial direction of a cleaning roller to guarantee smooth operation of a cleaning roller by preventing cleaning elements of a cleaning roller from colliding with elevations of a punch or a matrix.

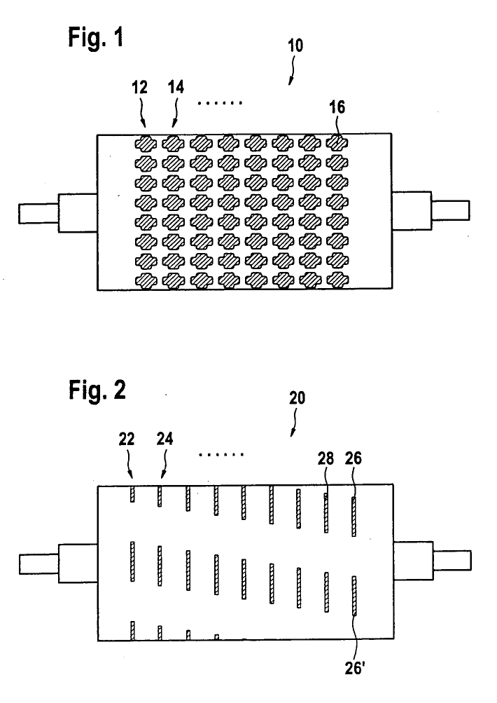

FIG. 1 is a schematic diagram showing an exemplary punch 10 in accordance with a first embodiment of the present invention. Punch 10 is fitted with an embossing pattern that includes elevations 16 arranged in rows 12 and 14 in a circumferential direction, which can be identical and cross shaped, when seen from above, whereby elevations 16 also are arranged in a checker board pattern.

FIG. 2 is a schematic diagram showing an exemplary cleaning roller 20 that can interact with punch 10 embodied in FIG. 1. Several cleaning elements 26, 26′ and 28 are arranged in rows 22 and 24 in a circumferential direction on cleaning roller 20. Cleaning elements 26 and 26′ of each row are spaced apart in a circumferential direction so that the cleaning function is briefly interrupted during operation, which prevents cleaning elements 26 and 26′ from clogging as they pass very closely by elevations 16. During interruption, collected paper fibers can be removed from in between cleaning elements 26 and 26′ and the cleaning roller 20. Cleaning elements 26 and 28 are radially spaced apart in an axial direction of a cleaning roller 20 in such a way that cleaning elements 26 and 28 successively run between spaced apart rows of elevations 16, preventing collisions between cleaning elements of cleaning roller 20 and elevations of punch 10. Cleaning elements 26 and 28 are radially offset in such a way that only one cleaning element 16 at any one time runs on an axial line of a cleaning roller 20.

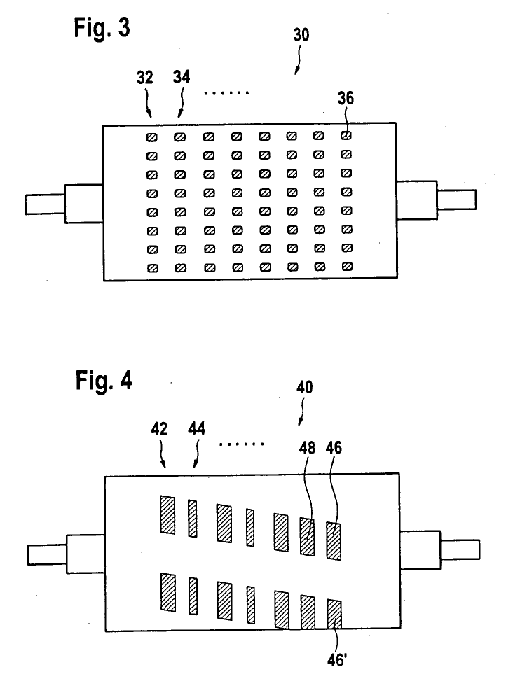

FIG. 3 is a schematic diagram showing an exemplary punch 30 in accordance with a second embodiment of the present invention. Punch 30 can be fitted with elevations 36 arranged in rows 32 and 34 in a checker board pattern, where the distance between the rows of elevations 32 and 34 is greater than the distance between the rows of elevations 12 and 14 in another embodiment of the present invention shown in FIG. 1.

FIG. 4 is a schematic diagram showing an exemplary cleaning roller 40 that can interact with punch 30 embodied in FIG. 3. Cleaning roller 40 is fitted with wider cleaning elements 46, 46′, and 48 than cleaning elements 26, 26′, and 28, shown in FIG. 2, such that paper fibers and dust collected between rows of elevations 32 and 34 are gathered.

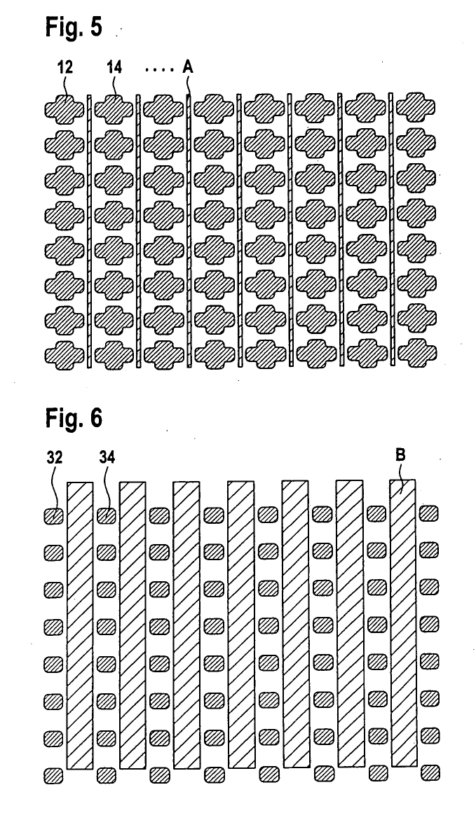

FIG. 5 is a schematic diagram showing an exemplary path A of cleaning elements 26, 26,′ and 28 on cleaning roller 20, embodied in FIG. 2, between elevations 16 on punch 10 embodied in FIG. 1. By geometrically complementing shapes of elevations 16 with dimensions of cleaning elements 26, 26′, and 28, fibers and dust can be removed from surfaces of embossing rollers to facilitate superior embossing results. Similarly, FIG. 6 is a schematic diagram showing an exemplary path B of cleaning elements 46, 46′, and 48 on cleaning roller 40 embodied in FIG. 4, between elevations 36 on punch 30 embodied in FIG. 3.

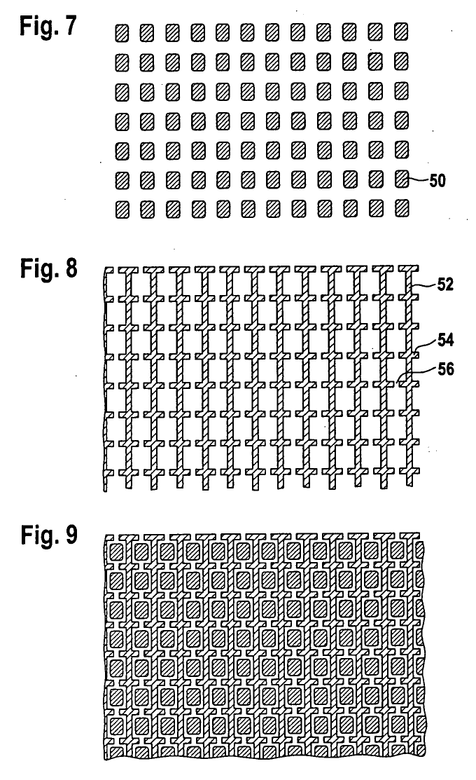

FIG. 7 is a schematic diagram showing an exemplary punch in accordance with a third embodiment of the present invention. FIG. 7 shows a pattern of regularly spaced-apart and substantially rectangular elevations 50 whose circumferential contour is slightly convex. FIG. 8 is a schematic diagram showing an exemplary cleaning roller that can interact with a punch such as that embodied in FIG. 7. Cleaning studs 52 that can run in a circumferential direction can be fitted with horizontally running element segments 54 that correspond with spaced-apart elevations 50, as shown in FIG. 7, of a punch, whereby axially neighboring element segments 54 are separated by a free space 56. FIG. 9 is a schematic diagram showing an exemplary path of cleaning elements embodied in FIG. 8 between elevations on a punch embodied in FIG. 7.

Although FIGS. 1-7 illustrate the present invention as applied to a punch, one of ordinary skill in the art would readily appreciate that the cleaning roller of the present invention could be applied in a similar manner to a matrix. Indeed, as stated above, cleaning elements can cooperate with either punches or matrixes, or both.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

What is claimed is:

1. A roller arrangement for embossing a web-shaped material, comprising:
at least one embossing roller defining an embossing pattern, wherein the embossing pattern comprises a plurality of elevations aligned in rows that are spaced apart in a circumferential direction; and
a cleaning roller defining a plurality of cleaning elements that are aligned between the rows of the at least one embossing roller.

2. The roller arrangement of claim 1, wherein the at least one embossing roller comprises a punch.

3. The roller arrangement of claim 1, wherein the at least one embossing roller comprises a matrix.

4. A roller arrangement for embossing a web-shaped material, comprising:
a punch defining a first embossing pattern, wherein the first embossing pattern comprises a first plurality of elevations aligned in rows that are spaced apart in a circumferential direction;
a matrix defining a second embossing pattern, wherein the second embossing pattern comprises a second plurality of elevations aligned in rows that are spaced apart in a circumferential direction; and
a cleaning roller defining a plurality of cleaning elements that are aligned between the rows of one of the punch and the matrix.

5. The roller arrangement of claim 4, wherein the plurality of elevations of the first embossing pattern is configured to align with free spaces between the plurality of elevations of the second embossing pattern.

6. The roller arrangement of claim 4, wherein the cleaning elements are aligned in a circumferential direction of the cleaning roller.

7. The roller arrangement of claim 4, wherein the cleaning elements interact with the one of the punch and the matrix in between the rows of elevations of the one of the punch and the matrix to remove sediment.

8. The roller arrangement of claim 4, wherein the cleaning elements are spaced apart in the circumferential direction of the cleaning roller.

9. The roller arrangement of claim 8, wherein the cleaning elements are radially offset in the axial direction of the cleaning roller.

10. The roller arrangement of claim 4, wherein the plurality of elevations of at least one of the first and second embossing patterns of the punch and matrix is arranged in a checker board pattern.

11. The roller arrangement of claim 4, wherein the web-shaped material is tissue material.

12. The roller arrangement of claim 4, wherein the web-shaped material is paper.

13. The roller arrangement of claim 4, wherein one of the first embossing pattern and the second embossing pattern is cross-shaped.

14. The roller arrangement of claim 4, wherein one of the first embossing pattern and the second embossing pattern is square-shaped.

15. The roller arrangement of claim 4, wherein one of the first embossing pattern and the second embossing pattern is oval-shaped.

16. A method for embossing web-shaped material comprising:
rolling the web-shaped material over an embossing roller, the embossing roller defining a plurality of elevations in rows that are spaced apart in a circumferential direction;
positioning a cleaning roller adjacent to the embossing roller, the cleaning roller defining a plurality of cleaning elements that are aligned between the rows of the embossing roller; and
running the plurality of cleaning elements in between the rows of the embossing roller to remove sediment.

17. The method of claim 16, further comprising running the plurality of cleaning elements intermittently in between the rows of the embossing roller to remove sediment.

18. The method of claim 16, further comprising arranging the plurality of cleaning elements radially offset on the cleaning roller such that only one cleaning element at any one time runs between the rows of the embossing roller.

19. The method of claim 16, further comprising running the plurality of cleaning elements successively between the rows of the embossing roller.

20. The method of claim 16, wherein the embossing roller comprises one of a punch and a matrix.
